(19) United States
(12) Patent Application Publication
(10) Pub. No.: US 2025/0065884 A1
(43) Pub. Date: Feb. 27, 2025

(54) METHOD FOR ESTIMATING COEFFICIENTS OF FRICTION, COMPUTER PROGRAM, CONTROLLER, VEHICLE, IN PARTICULAR UTILITY VEHICLE

(71) Applicants: ZF CV Systems Global GmbH, Bern (CH); ZF Friedrichshafen AG, Friedrichshafen (DE)

(72) Inventors: Felix Müller-Deile, Hannover (DE); Johannes Heseding, Hannover (DE); Franz Bitzer, Friedrichshafen (DE)

(21) Appl. No.: 18/943,564

(22) Filed: Nov. 11, 2024

Related U.S. Application Data
(63) Continuation of application No. PCT/EP2023/063205, filed on May 17, 2023.

(30) Foreign Application Priority Data
Jun. 3, 2022 (DE) 10 2022 114 084.9

(51) Int. Cl. B60W 40/068; B60W 50/00

(52) U.S. Cl. CPC B60W 40/068; B60W 2050/0052; B60W 2300/12; B60W 2520/26; B60W 2520/30

(57) ABSTRACT

A method is for estimating coefficients of friction for a vehicle, in particular utility vehicle, which can be driven by an electric drive. The method includes the steps of: operating, with a torque, a wheel of the vehicle, in particular utility vehicle, that is arranged on an underlying surface; ascertaining the slip of the wheel; applying a temporally predetermined excitation torque to the wheel, wherein the excitation torque is applied to the wheel periodically with a frequency; ascertaining a change in slip depending on the excitation torque, wherein the change in slip is ascertained taking into account the frequency; and ascertaining a coefficient of friction on the basis of the change in slip.

### CROSS-REFERENCE TO RELATED APPLICATIONS

This application is a continuation application of international patent application PCT/EP2023/063205, filed May 17, 2023, designating the United States and claiming priority from German application 10 2022 114 084.9, filed Jun. 3, 2022, and the entire content of both applications is incorporated herein by reference.

### TECHNICAL FIELD

The disclosure relates to a method for estimating coefficients of friction for a vehicle, in particular a utility vehicle, which can be driven by an electric drive. The disclosure also relates to a computer program and/or computer-readable medium, a controller for a vehicle, in particular a utility vehicle, and a vehicle, in particular a utility vehicle.

### BACKGROUND

The control of electric drives in vehicles, in particular utility vehicles such as e-trucks, e-buses and e-semitrailers, is known from the prior art. An electric drive is installed, for example, in a towing vehicle and/or in an electrified trailer. In electrically powered vehicles, especially utility vehicles, the electric drive is primarily used for traction, traction support and/or recuperation, that is, regenerative braking. In the following, utility vehicles are also referred to as vehicles for ease of description.

Automated driving functions are known for vehicles and in particular for traction, traction assistance and/or recuperation. For example, a traction function (Automatic Traction Control, ATC), a braking function (Anti-lock Braking System, ABS) and a stability function (Electronic Stability Control, ESC) are known as automated driving functions. The automated driving functions require reliable information about the road surface the vehicle is traveling on and the associated coefficient of friction in order to be carried out effectively and reliably. The maximum force that can be transmitted by the wheels is heavily dependent on the coefficient of friction of the road surface. If information relating to the coefficient of friction is missing, the respective automated driving function cannot intervene optimally from the start of the driving maneuver. Information regarding the road surface is not taken into account when performing the current automated driving functions. Situations may therefore arise in which the tires of the vehicle lock or spin despite ABS and ATC, for example.

If the traction, braking and stabilization functions do not estimate the coefficient of friction, it is not always possible to prevent the tires from locking or spinning on a road surface with a low coefficient of friction, which may lead to a critical driving situation. A short-term locking of the tires followed by a “run-on phase” with reduced braking force leads to an increase in braking distance. If the electric drive set up for regenerative braking is involved in braking, the recuperation power is limited in these phases and the recuperation potential is not sufficiently utilized.

In electrically powered vehicles, maximum utilization of recuperation is crucial for energy-efficient operation of the vehicle. It is also helpful to know information about the coefficient of friction of the road in order to be able to adjust the optimum slip on an electrically driven axle, for example, and thus enable recuperation without locking the tires.

In order to enable automated driving functions to function reliably and recuperation to be effective, it is therefore desirable to ascertain the coefficient of friction of the road surface in advance so that the automated driving functions and/or recuperation can be carried out taking the road surface coefficient of friction into account.

The currently known systems for ascertaining the road surface coefficient of friction are mainly based on additional sensors such as camera systems, moisture sensors and noise sensors, which on the one hand cause additional costs and on the other hand cannot differentiate between all road surfaces.

Camera-based systems can estimate the coefficient of friction of the road surface. These systems monitor the road surface in front of the vehicle and require additional evaluation units to analyze image material. Different ambient and lighting conditions, such as sun and shade, pose a problem. For example, it is difficult to distinguish between water and shade. The coefficient of friction of the road cannot be ascertained by measurement, but can only be analyzed and estimated using the camera image. The systems are still in need of improvement.

With the help of additional sensors in the region of the wheel arch, the rolling noise of the tire can be analyzed in order to achieve a coefficient of friction estimate with acoustic sensors. For example, the rolling noise on a wet road differs significantly from that on a dry road. The acoustic sensors can also be used in conjunction with moisture sensors. For these systems, an additional evaluation unit is required which identifies the road surface on the basis of the different rolling noises and enables the coefficient of friction to be estimated.

The coefficient of friction can also be ascertained with the help of defined wheel-specific test braking. However, these test brake applications lead to brake and tire wear and to a short-term increase in fuel and/or energy consumption. In addition, the friction brake cannot be precisely controlled and the ratio between brake pressure and braking force depends on many factors and can vary during the journey. Test braking cannot be carried out permanently, which means that the road surface can only be checked sporadically.

The methods for ascertaining coefficients of friction could be improved insofar as there is no direct measurement of the coefficient of friction of the road surface and/or the measurement is not energy-neutral and causes increased wear on the brakes and tires.

A drive of the vehicle can be used to estimate the coefficient of friction of the road surface. US 2007/0061061 A1 discloses a method for ascertaining a road surface condition. A specific vehicle acceleration or deceleration is induced by applying a torque to a driven wheel. Velocities of the driven wheel and a non-driven wheel are measured. A tire-road surface coefficient of friction and slip are calculated based on the speeds of the wheels.

Similarly, US 2010/0131165 A1 discloses a method for real-time identification of a maximum tire-road surface coefficient of friction by induced wheel acceleration/deceleration. In this method, a specific torque is applied to one axle at a specific frequency. Another axle is applied with a torque coordinated therewith to keep the vehicle acceleration or deceleration within a range intended by a driver and to prevent an adverse effect on the driver.

However, to ascertain the coefficient of friction, various disturbance variables are included that can influence the speed of the driven wheel. This results in a relatively high signal-to-noise ratio. A relatively large slip must therefore be generated by a corresponding torque in order to reliably ascertain the coefficient of friction. The torque must then be compensated for on another axle.

### SUMMARY

It is an object of the disclosure to enable a reliable and effective ascertainment of the road surface coefficient of friction using an electric drive, thereby supporting and improving the existing functions for coefficient of friction detection.

According to the disclosure, a method for estimating coefficients of friction for a vehicle, in particular a utility vehicle, driven by an electric drive is provided. The method includes the following steps: operating, with a torque, a wheel of the vehicle, in particular utility vehicle, that is arranged on an underlying surface; ascertaining the slip of the wheel; applying a temporally predetermined excitation torque to the wheel, wherein the excitation torque is applied to the wheel periodically with a frequency; ascertaining a change in slip depending on the excitation torque, the change in slip being ascertained taking into account the frequency; and ascertaining a coefficient of friction on the basis of the slip and the change in slip.

The method according to the disclosure is for estimating or ascertaining a coefficient of friction. The coefficient of friction of the road surface or the coefficient of friction is the ratio of a frictional force and a contact force acting between the wheel of the vehicle and the surface on which the wheel is arranged. The frictional force is a force acting tangentially to a contact area between the wheel and the underlying surface. The contact pressure force is a force acting normal, that is, perpendicular, to the contact area.

It is proposed to ascertain the coefficient of friction of the road surface via torque excitation by the electric drive, wherein the torque excitation with the excitation torque enables an evaluation of the change in slip induced by the torque excitation permanently while driving. For this purpose, the wheel is operated with a torque, the so-called stationary torque. Operating the wheel with the torque causes the slip to occur. In addition to the torque, the wheel is subjected to the periodic excitation torque. The excitation torque leads to the change in slip that can be ascertained, which can be used to estimate the coefficient of friction of the road surface. The excitation torque is predetermined in time by the frequency.

It has been recognized that the electric drive has high control dynamics and precise knowledge of the converted torque compared to an internal combustion engine and/or a friction brake. This enables the proposed method for ascertaining the coefficient of friction of the road surface. The electric drive and a high-frequency torque excitation are used to induce and evaluate minimal changes in slip and thus ascertain the coefficient of friction of the road surface.

The drive and braking torque required to accelerate, to drive at constant speed and/or to decelerate the vehicle is referred to below as “stationary torque”. Depending on the level of the “stationary torque” and the coefficient of friction of the road surface, a “stationary slip” occurs. This “stationary slip” is also dependent on the steering angle, float angle and the lateral guidance forces of the tire. The “stationary torque” can be distinguished from the excitation torque, as the frequency is assigned to the excitation torque, wherein the frequency is optionally fixed and constant. The “stationary torque” can be variable over time in order to cause different accelerations and/or decelerations of the wheel.

Due to the precise controllability and high dynamics of the electric drive, it can be used to estimate coefficients of friction of the road surface. No additional sensors are required to evaluate the coefficient of friction, which enables the coefficient of friction to be ascertained effectively and cost-efficiently. The method can be used to directly “measure” the slip behavior at different forces on the tire and thus ascertain the coefficient of friction of the road surface.

According to various embodiments, the frequency of the periodic excitation torque is in the range from 0.1 Hz to 20 Hz, preferably from 1 Hz to 5 Hz. This means that the excitation torque has a frequency that is advantageous for ascertaining the coefficient of friction. Below 0.1 Hz, vibration modes of the vehicle can be excited, which can be perceived as rocking of the vehicle and have a negative effect on the driving of the vehicle. Above 20 Hz, the signal-to-noise ratio (SNR) when ascertaining the change in slip decreases to such an extent that it is not possible to reliably ascertain the change in slip.

According to various embodiments, the change in slip is ascertained using a filter. Since the frequency of the excitation torque is known, the change in slip can be evaluated specifically for this frequency, whereby influences from measurement noise and/or other short-term events can be minimized. Alternatively or additionally, the change in slip is ascertained via a Fourier analysis of the change in slip. The change in slip, which is time-dependent due to the periodic excitation torque, is Fourier-transformed in order to ascertain a spectrum of the change in slip. The spectrum of the change in slip is frequency-dependent. By applying a filter to the spectrum of the change in slip, influences due to measurement noise and/or other short-term events can be minimized.

According to various embodiments, the filter is applied to the slip with regard to a predetermined interval including the frequency. This allows the filter to be specifically set to evaluate the change in slip over the interval. The interval is selected in such a way that the change in slip due to the excitation torque has a frequency in the interval. For example, the interval for this includes the frequency of the excitation torque.

According to various embodiments, the periodic excitation torque is applied to several wheels of the vehicle, in particular utility vehicle, with a predetermined phase shift. It was recognized that a phase shift of the excitation is advantageous for individual wheel drives. In particular, a phase shift of 180° is advantageous. The wheels can be assigned to one or more drive axles of the vehicle. Due to the phase shift, particularly by 180°, the excitation has little or no influence on the total torque acting on the vehicle and the resulting vehicle acceleration. If several electrically drivable axles, each with a central drive per electrically drivable axle, are involved in driving the vehicle, the phase shift can be applied to each axle. Compared to a central drive with only one drive axle, this allows higher excitation amplitudes without a negative effect on the vehicle dynamics in order to simplify the ascertainment of the change in slip.

According to various embodiments, the change in slip is ascertained using a lock-in amplifier. This can improve the signal-to-noise ratio of the ascertained change in slip. The lock-in amplifier receives the change in slip as an input as a measurement signal and the excitation torque as a reference signal with the known frequency. The lock-in amplifier ascertains the product of change in slip and excitation torque for a specific phase shift. This allows the slip amplification to be effectively and reliably amplified with regard to the excitation torque in order to suppress interference frequencies.

According to various embodiments, the method also includes the following steps: ascertaining an operating point based on the torque and the slip. A specific underlying surface has a specific relationship between coefficient of friction and slip. The relationship between the coefficient of friction and slip can be represented in a coefficient of friction curve that can be assigned to the underlying surface. The coefficient of friction can be ascertained by the ratio of the vehicle load acting on a wheel and a propulsive force acting on the wheel. This results in a specific operating point from the ascertained slip and the coefficient of friction, which can be assigned to one or more coefficient of friction curves and thus to underlying surfaces. The load acting on the wheel is the normal force, which results from the product of a mass times a location factor. It is also possible to ascertain the slip by considering a driven wheel and a non-driven wheel of the vehicle.

According to various embodiments, the method also includes the following steps: ascertaining a gradient of the coefficient of friction depending on the slip. It was recognized here that each coefficient of friction curve that can be assigned to an underlying surface has a certain relationship between the gradient of the coefficient of friction and slip, that is, a local increase for a certain slip of a coefficient of friction curve is characteristic of an underlying surface. If an excitation torque is given, the slip value on the electrically drivable axle changes with the same frequency. The excitation can be used to ascertain the slope at the operating point of the coefficient of friction curve. If the torque excitation only leads to a slight change in slip, this results in a high gradient for the coefficient of friction curve.

According to various embodiments, the method also includes the following steps: assigning a coefficient of friction curve corresponding to the underlying surface using the gradient of the coefficient of friction. The gradient or its dependence on the slip is a typical variable that can be assigned to a specific underlying surface. Alternatively or additionally, a coefficient of friction curve corresponding to the underlying surface is assigned using a stochastic variable of the coefficient of friction and/or the slip. The stochastic variable can, for example, be a variance, a standard deviation and/or an error of the ascertained coefficient of friction and/or the slip. It was recognized that the coefficient of friction and/or the slip can be measured differently depending on the underlying surface or road surface and is therefore subject to different fluctuations, which can be detected and classified using the stochastic variable. Alternatively or additionally, it is possible for the coefficient of friction curve corresponding to the underlying surface to be assigned using a fit of a curve, taking into account the operating point and the gradient of the coefficient of friction curve at the operating point. For this purpose, a functional relationship of the coefficient of friction curve defined by parameters can be assumed, wherein a mathematical optimization is performed to ascertain the parameters, taking into account the ascertained operating point and the ascertained gradient. It is possible to record a number of operating points in a predetermined time interval in order to carry out a fit of the coefficient of friction curve taking into account the number of operating points. Based on the parameters ascertained, the coefficient of friction curve can be assigned to the underlying surface.

According to various embodiments, the method further includes the steps of: ascertaining a maximum coefficient of friction of the underlying surface based on the coefficient of friction. If the slip changes comparatively strongly due to the excitation, the maximum value of the coefficient of friction is typically almost reached. Using the “stationary operating point” and the ascertained slope at this operating point, the current operating point can be assigned to a characteristic coefficient of friction curve. In addition, the maximum coefficient of friction of the road surface can be estimated using interpolation.

According to various embodiments, the excitation torque has an amplitude, wherein the amplitude is selected in such a way that a slip limit is not exceeded. This means that the amplitude of the torque excitation is advantageously selected so that the excitation is not felt by the driver and/or has negative effects on vehicle stability. For example, it is avoided that critical slip values cannot be achieved by the excitation torque alone on road surfaces with a low coefficient of friction, for example, ice. Additionally or alternatively, the excitation torque has an amplitude, wherein the amplitude is selected such that a sign of a sum of torque and excitation torque is equal to a sign of the torque. In other words, the resulting torque from the “stationary” torque and the periodic torque excitation does not change sign. This can prevent unwanted tooth flank changes in a vehicle transmission. Alternatively or additionally, the excitation torque has an amplitude, wherein the amplitude is selected in such a way that vehicle stability and/or efficiency are taken into account. In this way, excitation by the electric drive at an inefficient operating point can be avoided in order to suppress a reduction in the efficiency of the electric drive.

According to various embodiments, the slip is ascertained and a change in slip is ascertained using a plurality of wheel speed sensors and/or taking into account information relating to the speed of the electric drive. The existing wheel speed sensors of the vehicle can be used to evaluate the slip. Advantageously, the slip and the change in slip are ascertained by a wheel speed sensor arranged on a driven axle and a wheel speed sensor arranged on a non-driven axle. In the case of individual wheel drives, the speed signal can be the information relating to the speed of the electric drive and can be used in particular for plausibility checks, as it may have a higher resolution and faster sampling rate. In addition or alternatively, the slip and the change in slip are ascertained by two wheel speed sensors arranged on a driven axle on optionally different sides of the vehicle in order to be able to ascertain different coefficients of friction for each wheel. This allows the coefficient of friction to be taken into account specifically for the respective wheel and/or a “critical wheel” to be identified, that is, the wheel that is operated closer to the slip limit.

According to an aspect of the disclosure, a computer program and/or a computer-readable medium is provided. The computer program and/or computer-readable medium includes instructions which, when the program or instructions are executed by a computer, cause the computer to perform the method according to the disclosure and/or steps thereof. Optionally, the computer program and/or the computer-readable medium includes instructions which, when the program or instructions are executed by a computer, cause the computer to perform the method steps described as being advantageous or optional to achieve a technical effect associated therewith.

According to an aspect of the disclosure, a controller for a vehicle, in particular a utility vehicle, is provided. The controller is set up to perform the method according to the disclosure. Optionally, the controller is set up to carry out the method steps described as being advantageous or optional in order to achieve a technical effect associated therewith.

According to an aspect of the disclosure, a vehicle, in particular a utility vehicle, is provided with a controller according to the disclosure. Optionally, the controller of the vehicle and/or the vehicle is set up to perform the method steps described as advantageous or optional in order to achieve a technical effect associated therewith.

### BRIEF DESCRIPTION OF DRAWINGS

The invention will now be described with reference to the drawings wherein:

FIG. 1 shows a schematic representation of a flow chart of a method according to an embodiment of the disclosure;

FIGS. 2A and 2B show two schematic representations of coefficient of friction curves; and,

FIG. 3 shows a schematic representation of an overview of a vehicle, in particular a utility vehicle, according to an embodiment of the disclosure.

### DETAILED DESCRIPTION

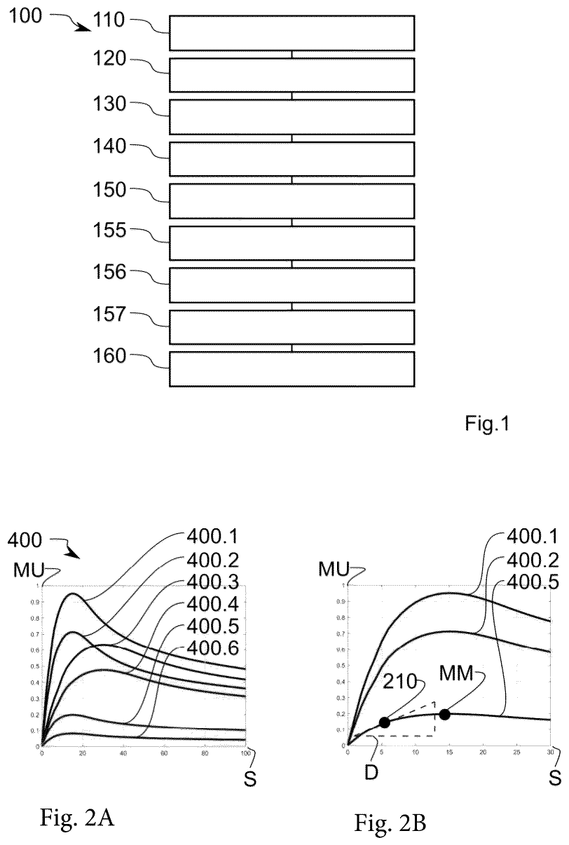

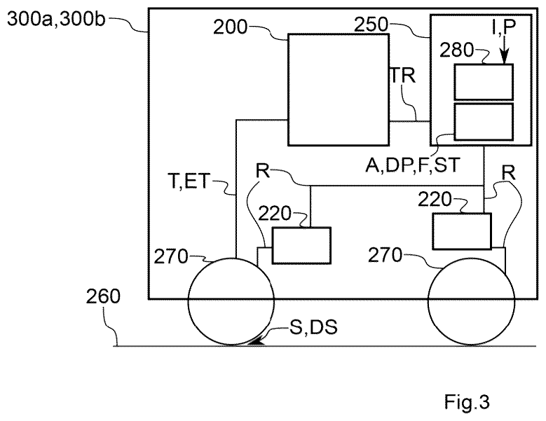

FIG. 1 shows a schematic representation of a flow chart of a method 100 according to an embodiment of the disclosure. In particular, FIG. 1 shows a method 100 for estimating the coefficient of friction for a vehicle 300a, in particular a utility vehicle 300b, which can be driven by an electric drive 200. The vehicle 300a, in particular utility vehicle 300b, is hereinafter referred to as vehicle 300a, 300b. The vehicle 300a, 300b is described in greater detail with reference to FIG. 3.

The method 100 according to FIG. 1 begins with operating 110, with a torque T, a wheel 270 of the vehicle 300a, 300b arranged on an underlying surface 260. The operation 110 is an acceleration, travel at constant speed, or deceleration of the wheel 270. The torque T for acceleration or deceleration, that is, the driving or braking torque which is used for acceleration, travel at constant speed, and deceleration of the vehicle 300a, 300b, is also referred to as “stationary” torque T.

The slip S of the wheel 270 is ascertained 120. The slip S establishes as a “stationary” slip S depending on the level of the “stationary” torque T and a coefficient of friction MU of the road surface. This “stationary” slip S is also dependent on an optional steering angle, a float angle and lateral guidance forces of the tire or the wheel 270. FIGS. 2A and 2B show coefficient of friction curves 400, that is, the relationship between the coefficient of friction MU and the slip S for different road surfaces or underlying surfaces 260. The underlying surface 260 on which the vehicle 300a, 300b is driving and the corresponding coefficient of friction curve 400 are not known while driving and can change while driving.

In FIG. 1, a predetermined excitation torque ET is applied 130 to the wheel 270, wherein the excitation torque ET is applied 130 to the wheel 270 periodically at a frequency F. The periodic excitation torque ET can be realized idealized as a time-dependent angular function, as a time-dependent rectangular function and/or as a sum of such functions of the excitation torque ET. The frequency F of the periodic excitation torque ET is in the range from 0.1 Hz to 20 Hz, preferably from 0.5 Hz to 5 Hz.

The excitation torque ET has an amplitude A, wherein the amplitude A is selected such that a slip limit ST is not exceeded, a sign of a sum of torque T and excitation torque ET is equal to a sign of the torque T and the vehicle stability and/or efficiency are taken into account.

The periodic excitation torque ET and a predetermined phase shift DP are applied 130 to a plurality of wheels 270 of the vehicle 300a, 300b. As a result, the excitation torques ET associated with the various wheels 270 are predetermined in time by the frequency and the phase shift DP. The plurality of wheels 270 may be associated with one or more axles of the vehicle 300a, 300b. The phase shift DP is 180°, for example.

A change in slip DS is then ascertained 140 depending on the excitation torque ET. If a high-frequency torque excitation with the excitation torque ET is additionally applied to the “stationary” torque T, the slip S on the electrically driven axle changes by the change in slip DS with the same frequency. The change in slip DS is ascertained 140 taking into account the frequency F and using a filter P and/or a Fourier analysis of the change in slip DS. The filter P is applied to the slip S with respect to a predetermined interval I including the frequency F. The change in slip DS is ascertained 140 using a lock-in amplifier 280. The Fourier analysis of the change in slip DS can be used to examine a measurement signal associated with the change in slip DS for a specific frequency. In particular, the measurement signal can be analyzed for the frequency F and/or an interval I around the frequency F.

The slip S is ascertained 120 and a change in slip DS is ascertained 140 by a plurality of wheel speed sensors 220 and is optionally checked for plausibility by the electric drive 21.

A coefficient of friction MU is then ascertained 150 using the change in slip DS. The change in slip DS causes a change in the tangential force or propulsive force at a contact area between the wheel 270 and the underlying surface 260. This results in a change in the coefficient of friction MU from the change in slip DS.

An operating point 210 is then ascertained 155 using the torque T and the slip S. The operating point 210 is a “stationary” operating point 210 and is a point on a coefficient of friction curve 400 (see FIGS. 2A and 2B), which can be ascertained using the “stationary” torque T and the “stationary” slip S associated with it. The excitation by the excitation torque ET and the change in slip DS can be used to ascertain the slope at operating point 210 of the coefficient of friction curve 400, as the coefficient of friction MU changes as a result of the change in slip DS.

This is followed by an ascertainment 156 of a gradient D of the coefficient of friction MU depending on the slip S. If the torque excitation by the excitation torque ET only leads to a small change in slip DS, this results in a high gradient D for the coefficient of friction curve 400.

A coefficient of friction curve 400 corresponding to the underlying surface 260 is assigned 157 using the gradient D of the coefficient of friction MU and using a stochastic variable of the coefficient of friction MU and/or the slip S. Using the “stationary” operating point 210 and the ascertained slope or the gradient D at the operating point 210, the current operating point 210 can be assigned to a characteristic coefficient of friction curve 400.

A maximum coefficient of friction MM of the underlying surface 260 is ascertained 160 using the coefficient of friction MU. At a high gradient D, the current operating point 210 is far away from the maximum coefficient of friction MM, which indicates a high coefficient of friction MU of the road surface. However, if the slip S changes significantly due to the excitation, the maximum coefficient of friction MM is almost reached. In addition, the maximum coefficient of friction MM of the road surface can be estimated via interpolation. The direct correlation between torque excitation, slip value change DS and coefficient of friction MU of the road can be used to ascertain at any time whether the current operating point 210 is already close to the slip limit ST or not.

A person skilled in the art recognizes that the steps of the method 100 can also be carried out in a sequence other than that shown. Steps of the method can also be performed simultaneously, that is, at the same time. For example, the operation 110 with the torque T of the wheel 270 arranged on the underlying surface 260 and the application 130 of the predetermined excitation torque ET to the wheel 270 can take place at any time and, in particular, simultaneously. The ascertainment 120 of the slip S can take place at any time after the operation 110, with the torque T, of the wheel 270 arranged on the underlying surface 260.

FIGS. 2A and 2B show two schematic representations of coefficient of friction curves 400.1, 400.2, 400.3, 400.3, 400.4, 400.5, 400.6.

FIG. 2A shows six different coefficient of friction curves 400.1, 400.2, 400.3, 400.3, 400.4, 400.5, 400.6. Each of the coefficient of friction curves 400.1, 400.2, 400.3, 400.3, 400.4, 400.5, 400.6 represents the relationship between coefficient of friction MU and slip S for a specific underlying surface 260. The coefficient of friction curve 400.1 shows the relationship between coefficient of friction MU and slip S for dry asphalt. The coefficient of friction curve 400.2 shows the relationship between coefficient of friction MU and slip S for wet asphalt. The coefficient of friction curve 400.3 shows the relationship between coefficient of friction MU and slip S for crushed stone and/or gravel. The coefficient of friction curve 400.4 shows the relationship between coefficient of friction MU and slip S for wet crushed stone and/or gravel. The coefficient of friction curve 400.5 shows the relationship between coefficient of friction MU and slip S for snow. The coefficient of friction curve 400.6 shows the relationship between coefficient of friction MU and slip S for ice.

Each of the coefficient of friction curves 400.1, 400.2, 400.3, 400.3, 400.4, 400.5, 400.6 has a unimodal shape with a maximum coefficient of friction MM at a certain slip S (see FIG. 2B), wherein the slope or the gradient D (see FIG. 2B) of each of the coefficient of friction curves 400.1, 400.2, 400.3, 400.3, 400.4, 400.5, 400.6 is positive and comparatively large for a smaller slip S and is negative and comparatively small for a larger slip S, as also described with reference to FIG. 2B.

FIG. 2B shows a detail for a selection of the coefficient of friction curves 400.1, 400.2, 400.5 as shown in FIG. 2A. An operating point 210 is shown here for one of the coefficient of friction curves 400.5. The operating point 210 results from the “stationary” torque T and the associated coefficient of friction MU and slip S. A slope triangle for ascertaining the gradient D is shown at the operating point 210. The gradient D is the local slope of the coefficient of friction curve 400.5. The excitation torque ET induces a change in slip DS and a change in the coefficient of friction MU. This allows the gradient D to be ascertained on the basis of the change in slip DS and the change in the coefficient of friction MU. The gradient D and the operating point 210 provide information about the coefficient of friction curve 210 and enable the assignment 157 of the coefficient of friction curve 400.5 corresponding to the respective underlying surface 260 using the gradient D of the coefficient of friction MU.

The maximum coefficient of friction MM is shown for the coefficient of friction curve 400.5. The gradient D of the coefficient of friction curve 400.5 is positive and comparatively large for a smaller slip S and negative and comparatively small for a larger slip S.

FIG. 3 shows a schematic representation of an overview of a vehicle 300a, in particular a utility vehicle 300b, according to an embodiment of the disclosure. The vehicle 300a, 300b according to FIG. 3 is described with reference to the description of FIGS. 1 and 2.

As shown in FIG. 3, the vehicle 300a, 300b is arranged on an underlying surface 260. The wheels 270 are arranged on the underlying surface 260. A contact area, not shown, is arranged between the wheels 270 and the underlying surface 260. The wheels 270 and the underlying surface 260 contact each other at the contact area. Forces can act between the wheels 270 and the underlying surface 260 through the contact area. In particular, a normal force can act perpendicular to the contact area, which depends on the mass of the vehicle 300a, 300b and the number and geometry of the wheels 270. In addition to the normal force, a tangential force can act, which depends on the dynamics of the respective wheel 270, in particular on propulsion and/or braking or the corresponding torque T and/or the excitation torque ET in the case of a driven wheel 270. The ratio of normal force to tangential force describes the coefficient of friction MU of the surface 260. The torque T causes a slip S and the excitation torque ET causes a change in slip DS. The slip S is the ratio of a speed R of a driven wheel 270 to a speed R of a non-driven wheel 270 that co-rotates form-fittingly.

The vehicle 300a, 300b is set up to perform the method 100 described with reference to FIG. 1. For this purpose, as shown in FIG. 3, the vehicle 300a, 300b includes a controller 250, an electric drive 200, the plurality of wheels 270 and the plurality of wheel speed sensors 220. The controller 250 is connected to the electric drive 200 and the wheel speed sensors 220 so as to perform the method 100 according to FIG. 1.

The controller 250 is set up to control the electric drive 200 for applying the torque T and the excitation torque ET to the wheels 270. For this purpose, the controller 250 can transmit a torque request TR to the electric drive 200, which defines the torque T and the excitation torque ET, wherein the amplitude A of the excitation torque ET, the phase shift DP of the excitation torque ET, the frequency F of the excitation torque ET and the slip limit ST are taken into account for the torque request TR. The controller 250 transmits the instantaneous torque request TR to the electric drive 200 for this purpose. The torque request TR consists of a superimposition of a “stationary” torque request for the “stationary” torque T with the additionally superimposed excitation torque ET. The frequency F, the amplitude A, the phase shift DP and the slip limits ST are stored in the controller 250 and are used to “generate” the excitation torque ET, which is added to the “stationary” torque T. The electric drive 200 receives an instantaneous value of a total torque as the sum of torque T and excitation torque ET, which then changes periodically due to the superimposed excitation torque ET. The electric drive 200 is set up to apply the torque T and the excitation torque ET to the wheel or wheels 270 using the signal from the controller 250.

Each of the wheel speed sensors 220 is set up to measure the speed R of one of the wheels 270. The slip S and the change in slip DS can be ascertained with the aid of several wheel speed sensors 220. For this purpose, one of the wheel speed sensors 220 is set up to ascertain the rotational speed R of a non-driven wheel 270, and one of the wheel speed sensors 220 is set up to ascertain the rotational speed R of a driven wheel 270. The wheel speed sensor 220 is connected to the controller 250 for transmitting the rotational speeds R of the wheels 270 to the controller 250. The controller 250 is set up to ascertain the slip S and the change in slip DS on the basis of the rotational speeds R of the wheels 270.

The controller 250 is also set up to form a lock-in amplifier 280. For this purpose, the controller 250 can provide the interval I and the filter P to the lock-in amplifier 280.

The controller 250 also includes a data processing device (not shown) and a memory (not shown). For example, the coefficient of friction curves 400 shown in FIGS. 2A and 2B can be stored in the memory. A coefficient of friction curve 400 and/or a coefficient of friction increase curve are stored in the memory for a set of underlying surfaces 260 in order to be able to effectively carry out the method 100 according to FIG. 1. The coefficient of friction curves 400 may have been obtained by measurement and/or modeled heuristically.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

100 method
110 operating a wheel
120 ascertaining the slip
130 applying excitation torque
140 ascertaining a change in slip
150 ascertaining a coefficient of friction
155 ascertaining an operating point
156 ascertaining a gradient
157 assigning a coefficient of friction curve
160 ascertaining a maximum coefficient of friction
200 electric drive
210 operating point
220 wheel speed sensor
250 controller
260 underlying surface
270 wheel
280 lock-in amplifier
300a vehicle
300b utility vehicle
400 coefficient of friction curve
A amplitude
D gradient
DP phase shift
DS change in slip
ET excitation torque
F frequency
MM maximum coefficient of friction
MU coefficient of friction
P filter
R speed
S slip
ST slip limit
T torque
TR torque requirement

1. A method for estimating the coefficient of friction for a vehicle which can be driven by an electric drive, the method comprising:
operating, with a torque, a wheel of the vehicle arranged on an underlying surface;
ascertaining a slip of the wheel;
applying a predetermined excitation torque to the wheel, wherein the predetermined excitation torque is applied to the wheel periodically at a frequency;
ascertaining a change in slip depending on the predetermined excitation torque, wherein the change in slip is ascertained taking into account the frequency; and,
ascertaining the coefficient of friction on the basis of the slip and the change in slip.

2. The method of claim 1, wherein the frequency of the predetermined excitation torque is in a range from 0.1 Hz to 20 Hz.

3. The method of claim 1, wherein the frequency of the predetermined excitation torque is in a range from 0.5 Hz to 5 Hz.

4. The method of claim 1, wherein the change in slip is ascertained at least one of using a filter and via Fourier analysis of the change in slip.

5. The method of claim 4, wherein the filter is applied to the slip with respect to a predetermined interval including the frequency.

6. The method of claim 1, wherein the predetermined excitation torque is applied to a plurality of wheels of the vehicle with a predetermined phase shift.

7. The method of claim 1, wherein the change in slip is ascertained using a lock-in amplifier.

8. The method of claim 1 further comprising ascertaining an operating point on a basis of the torque and the slip.

9. The method of claim 8 further comprising ascertaining a gradient of the coefficient of friction depending on the slip.

10. The method of claim 9 further comprising assigning a coefficient of friction curve corresponding to the underlying surface on a basis of at least one of the gradient of the coefficient of friction, a stochastic variable of the coefficient of friction, and a stochastic variable of the slip.

11. The method of claim 1, further comprising ascertaining a maximum coefficient of friction of the underlying surface on a basis of the coefficient of friction.

12. The method of claim 1, wherein the excitation torque has an amplitude; and, the amplitude is selected such that at least one of a slip limit is not exceeded, a sign of a sum of the torque and the excitation torque is equal to a sign of the torque, a vehicle stability is taken into account, and an efficiency is taken into account.

13. The method of claim 1, wherein the slip is ascertained and the change in slip is ascertained by at least one of a plurality of wheel speed sensors and taking into account information of the electric drive relating to a speed.

14. The method of claim 1, wherein the vehicle is a utility vehicle.

15. A computer program configured, when the computer program is executed by a computer, to cause the computer to perform the method of claim 1.

16. A computer program and/or computer-readable medium having commands stored thereon, wherein the commands, when executed by a computer, cause the computer to carry out the method of claim 1.

17. A controller for a vehicle comprising:
a processor;
a non-transitory computer readable medium having program code stored thereon;
said program code being configured, when executed by said processor, to:
operate, with a torque, a wheel of the vehicle arranged on an underlying surface;
ascertain a slip of the wheel;
apply a predetermined excitation torque to the wheel, wherein the predetermined excitation torque is applied to the wheel periodically at a frequency;
ascertain a change in slip depending on the predetermined excitation torque, wherein the change in slip is ascertained taking into account the frequency; and,
ascertain a coefficient of friction on the basis of the slip and the change in slip.

18. The controller of claim 17, wherein the vehicle is a utility vehicle.

19. A vehicle comprising:
a controller having a processor and a non-transitory computer readable medium having program code stored thereon;
said program code being configured, when executed by said processor, to:
operate, with a torque, a wheel of the vehicle arranged on an underlying surface;
ascertain a slip of the wheel;
apply a predetermined excitation torque to the wheel, wherein the predetermined excitation torque is applied to the wheel periodically at a frequency;
ascertain a change in slip depending on the predetermined excitation torque, wherein the change in slip is ascertained taking into account the frequency; and,
ascertain a coefficient of friction on the basis of the slip and the change in slip.

20. The vehicle of claim 19, wherein the vehicle is a utility vehicle.
